(19) United States
(12) Patent Application Publication
(10) Pub. No.: US 2026/0112077 A1
(43) Pub. Date: Apr. 23, 2026

(54) IMAGE GENERATION METHOD, DEVICE, AND MEDIUM

(71) Applicant: Beijing Zitiao Network Technology Co., Ltd., Beijing (CN)

(72) Inventor: Li Chen, Beijing (CN)

(21) Appl. No.: 19/346,341

(22) Filed: Sep. 30, 2025

(30) Foreign Application Priority Data
Oct. 17, 2024 (CN) 202411455533.9

(51) Int. Cl. G06T 11/00

(52) U.S. Cl. CPC G06T 11/00; G06T 2211/441

(57) ABSTRACT

An image generation method, an electronic device and a medium are provided. The method includes: acquiring a reference image and text prompt information; generating an initial Gaussian noise map based on the reference image; acquiring information of a target object in the reference image, and generating a target Gaussian noise map based on the information of the target object and the initial Gaussian noise map; and generating a target image by a target network model based on the target Gaussian noise map and the text prompt information.

### CROSS-REFERENCE TO RELATED APPLICATION

This application claims priority to Chinese Patent Application No. 202411455533.9 filed on Oct. 17, 2024, the disclosure of which is incorporated herein by reference in its entirety as part of this application.

### TECHNICAL FIELD

Embodiments of the present disclosure relates to an image generation method, an electronic device and a medium.

### BACKGROUND

In order to meet personalized needs of users or enrich image visual effects, network models such as generative models are used in more and more image processing scenarios to generate new images based on original images (such as the user's input image). However, inventors have found in research that the existing image generation effect is not good, and improvement is urgently required.

### SUMMARY

In order to solve the above problem or at least partially solve the above problem, embodiments of the present disclosure provide an image generation method, an apparatus, an electronic device and a medium.

Embodiments of the present disclosure provide an image generation method, the method comprises: acquiring a reference image and text prompt information; generating an initial Gaussian noise map based on the reference image; acquiring information of a target object in the reference image, and generating a target Gaussian noise map based on the information of the target object and the initial Gaussian noise map; and generating a target image by a target network model based on the target Gaussian noise map and the text prompt information.

Optionally, the generating an initial Gaussian noise map based on the reference image comprises: performing high-order ordinary differential equation reverse solving processing on the reference image to obtain the initial Gaussian noise map.

Optionally, the generating a target Gaussian noise map based on the information of the target object and the initial Gaussian noise map comprises: determining a first Gaussian noise corresponding to a first region based on the information of the target object and the initial Gaussian noise map; in which the first region is at least part of a region in the target Gaussian noise map to be generated, and the first region is determined based on the target object in the reference image; acquiring a second Gaussian noise corresponding to a second region; in which the second region is a region other than the first region in the target Gaussian noise map to be generated; and generating the target Gaussian noise map based on the first Gaussian noise and the second Gaussian noise.

Optionally, the determining a first Gaussian noise corresponding to a first region based on the information of the target object and the initial Gaussian noise map comprises: determining a target region noise in the initial Gaussian noise map based on a target object region of the reference image; scaling the target region noise based on the information of the target object to obtain a scaled region noise; and obtaining the first Gaussian noise corresponding to the first region based on the scaled region noise.

Optionally, the scaling the target region noise based on the information of the target object to obtain a scaled region noise comprises: determining a presentation type of the target object in the reference image based on the information of the target object; determining a target scaling strategy corresponding to the presentation type of the target object from a plurality of preset scaling strategies; in which scaling ratios corresponding to different scaling strategies are different; and scaling the target region noise based on the target scaling strategy to obtain the scaled region noise.

Optionally, the presentation type of the target object comprises: a first type, a second type, or a third type; the first type is used for indicating that all parts of the target object are present in the reference image; the second type is used for indicating that only a local part of the target object is present in the reference image, and the local part comprises at least a first specified part and a second specified part; the third type is used for indicating that only the first specified part of the target object is present in the reference image.

Optionally, the first type is a full-body portrait type, the second type is a half-body portrait type, and the third type is a head portrait type; the information of the target object is characterized by an object segmentation map of the reference image, pixels in a region in the object segmentation map except for the target object are all zero-pixels; the determining a presentation type of the target object in the reference image based on the information of the target object comprises: dividing the object segmentation map into an upper region and a lower region based on a center line of the object segmentation map, and calculating a first proportion of non-zero pixels in the upper region and a second proportion of non-zero pixels in the lower region; determining the presentation type of the target object in the reference image to be the head portrait type in response to both the first proportion and second proportion being greater than a first threshold that is preset; determining the presentation type of the target object in the reference image to be the half-body portrait type in response to the first proportion being less than a second threshold that is preset, and the second proportion being greater than the first threshold; in which the second threshold is less than the first threshold; and determining the presentation type of the target object in the reference image to be the full-body portrait type in response to both the first proportion and the second proportion being less than the second threshold.

Optionally, a scaling ratio corresponding to the first type is greater than a scaling ratio corresponding to the second type, and the scaling ratio corresponding to the second type is greater than a scaling ratio corresponding to the third type.

Optionally, the obtaining the first Gaussian noise corresponding to the first region based on the scaled region noise comprises: determining a region, where the scaled region noise corresponds to, in the target Gaussian noise map to be generated based on the presentation type of the target object, and taking the region determined as the first region; in which the first region has a preset relative positional relationship with a specified central position of the target Gaussian noise map, and relative positional relationships corresponding to different presentation types are different; and taking the scaled region noise as the first Gaussian noise to which the first region corresponds.

Optionally, the second Gaussian noise is random noise; and the generating a target Gaussian noise map based on the first Gaussian noise and the second Gaussian noise comprises: performing weighted superposition processing on a first Gaussian noise corresponding to an edge region in the first region and the second Gaussian noise to obtain a third Gaussian noise corresponding to the edge region in the first region; and generating the target Gaussian noise map based on a first Gaussian noise corresponding to a non-edge region in the first region, the third Gaussian noise corresponding to the edge region in the first region, and the second Gaussian noise corresponding to the second region.

Embodiments of the present disclosure further provide an image generation apparatus, which comprises: an information acquisition module, configured to acquire a reference image and text prompt information; an initial noise generation module, configured to generate an initial Gaussian noise map based on the reference image; a target noise generation module, configured to acquire information of a target object in the reference image, and generating a target Gaussian noise map based on the information of the target object and the initial Gaussian noise map; and an image generation module, configured to generate a target image by a target network model based on the target Gaussian noise map and the text prompt information.

Embodiments of the present disclosure further provide an electronic device, which comprises: a storage apparatus, on which a computer program is stored; and a processing apparatus, configured to execute the computer program in the storage apparatus for implementing steps of the image generation method provided by the embodiments of the present disclosure.

Embodiments of the present disclosure further provide a computer-readable storage medium, which stores a computer program thereon for executing the image generation method provided by the embodiments of the present disclosure.

Embodiments of the present disclosure further provide a computer program product, which comprises a computer program, when the computer program is executed by a processor, the processor is caused to implement the image generation method provided by the embodiments of the present disclosure.

### BRIEF DESCRIPTION OF DRAWINGS

The accompanying drawings, which are incorporated in the specification and constitute a part of the specification, illustrate embodiments of the present disclosure and, and together with the description, serve to explain principles of the present disclosure.

In order to illustrate the embodiments of the present disclosure or the technical solutions in the related art more clearly, the following brief introduction will be made to the drawings used in the description of the embodiments or the related art, and it would have been obvious for a person of ordinary skill in the art to obtain other drawings according to these drawings without involving any inventive effort.

FIG. 1 is a schematic diagram of a flow of an image generation method provided by embodiments of the present disclosure;

FIG. 2 is a comparative schematic diagram of a target Gaussian noise map provided by embodiments of the present disclosure;

FIG. 3 is a schematic diagram of an image generation flow provided by embodiments of the present disclosure;

FIG. 4 is a schematic diagram of a structure of an image generation apparatus provided by embodiments of the present disclosure; and

FIG. 5 is a schematic diagram of a structure of an electronic device provided by embodiments of the present disclosure.

### DETAILED DESCRIPTION

In order that the foregoing objects, features, and advantages of the present disclosure can be more clearly understood, solutions of the present disclosure will be illustrated further. It should be noted that the features in different embodiments of the present disclosure may be combined with each other without conflict.

In the following description, specific details are set forth in order to provide a thorough understanding of the present disclosure, but the present disclosure may be implemented in methods other than the methods described herein. It is to be understood that the embodiments in the description are only a part of the embodiments of the present disclosure, not all of them.

Image generation using a generative model such as a diffusion model has been widely used in the field of image generation at present, and the above-mentioned model can generate a clear image by gradually removing noise from random Gaussian noise based on a reference image provided by a user. The inventors have found that the image generation effect of the related art is not good and it is difficult to meet the user's requirements, one of the key reasons is that the related art is difficult to better balance the object consistency (i.e. the similarity between the object features in the generated image and the reference image) and the image editing capability, for example, when the similarity between the object features in the generated image and the reference image is high, the editing capability of the model for the image is often limited, and it is difficult to achieve flexible adjustment of the object presentation effect in the generated image. On the other hand, when the model has a strong image editing capability, allowing a large change in the object, such as changing from a front view to a side view of the object, changing from a half-body image to a full-body image, a large change in the object's limb movements, facial expressions, etc., the object consistency is usually sacrificed, resulting in a significant deviation in the characteristics of the object in the generated image and the object in the reference image, and a low degree of similarity. However, the inventors have further found that the above-mentioned problems can be at least partially solved by using the noise required by a model, and the related art basically ignores the importance of noise and is mostly realized by using random noise, etc. However, in fact, the noise required by a model not only determines the basic composition of a generated image but also has a relatively far-reaching influence on the quality and diversity of the generated image. Therefore, the embodiments of the present disclosure provide an image generation method, apparatus, device, and medium, which optimizes the construction manner of the noise required by a model, and on this basis helps to ensure the similarity between object features in an image generated by a model and a reference image. Moreover, it can guarantee the image editing capability and enrich the object presentation effect of the image generated by the model.

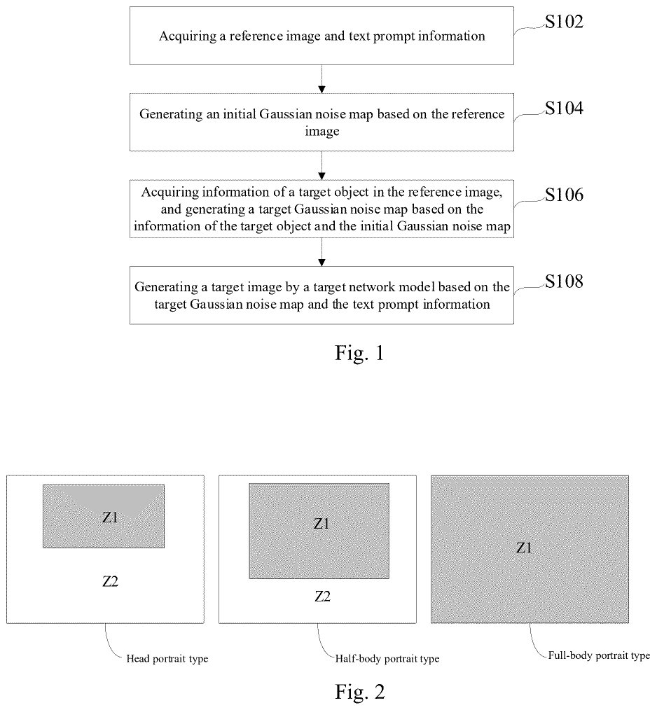

FIG. 1 is a schematic diagram of a flow of an image generation method provided by embodiments of the present disclosure, which may be performed by an image generation apparatus, the apparatus may be implemented in software and/or hardware, and may be generally integrated in an electronic device. As shown in FIG. 1, the method mainly includes the following steps S102-S108.

Step S102: acquiring a reference image and text prompt information. Illustratively, the reference image may be an image input by the user, and the text prompt information may be information input by the user, or may be default information, the embodiments of the present disclosure are not limited thereto. Here, the text prompt information may be used to instruct the target network model to perform image generation based on the reference image, and may further indicate an image effect expected to be generated by the model, such as an image style, an editing effect on the object in the reference image, etc. and the embodiments of the present disclosure do not limit the specific contents of the reference image and the text prompt information.

Step S104: generating an initial Gaussian noise map based on the reference image.

Embodiments of the present disclosure are capable of converting a clear reference image into an initial Gaussian noise map that carries the reference image information to some extent based on the clear reference image. In order to ensure the effect of noise map generation, in some specific implementation examples, high-order ordinary differential equation reverse solving processing can be performed on the reference image, to obtain the initial Gaussian noise map. Illustratively, the reference image may be processed using a high-order ordinary differential equation reverse solving technique such as a DPM-Solver (Diffusion Probabilistic Models Solver). In particular, based on the high-order ordinary differential equation reverse solving technique, the corresponding initial Gaussian noise map is generated for the reference image by using the diffusion model. The diffusion model can perform diffusion processing based on the noise of the previous time step, so as to obtain the noise of the current time step, and finally convert the reference image into an initial Gaussian noise map in a time step-by-step manner.

Because the initial Gaussian noise map is generated based on the reference image, the initial Gaussian noise map has a strong correlation/relevance with the reference image. In addition, compared with the method of first order ordinary differential equation, the method of high-order ordinary differential equation reverse solving can generate the initial Gaussian noise map faster and control the reverse process more accurately, and can restore the noise map to the original figure quickly and accurately based on the noise map, and the reliability of the model processing based on the initial Gaussian noise map is also stronger.

Step S106: acquiring information of a target object in the reference image, and generating a target Gaussian noise map based on the information of the target object and the initial Gaussian noise map.

The embodiments of the present disclosure do not specifically limit the type of the target object, for example, the target object may be a character, and may specifically be a character with a specified style, such as an anime character, a cartoon character, etc. or the target object may also be an animal or an object, and may specifically be a humanoid animal or a humanoid object, etc. which can be specifically flexibly set, and in practical application, the type of the target object required to be processed can be flexibly specified according to requirements.

In practical application, the target object in the reference image may be determined by means such as an object detection algorithm, and the information of the target object may include, for example, one or more from a group consisting of position information of the target object in the reference image, percentage information of the target object in the reference image, location/part information of the target object (such as location/part type and/or location/part size), type of the target object, and the like, which are not limited. In other examples, a segmentation map of the target object (i.e., an object segmentation map) may also be obtained by an object segmentation algorithm, and the information of the target object is directly characterized by the object segmentation map of the reference image. Based on the information of the target object, the target Gaussian noise map can be generated by combining the initial Gaussian noise map with a strong correlation/relevance with the reference image, and the target Gaussian noise map is further fused with the information of the target object based on the information of the reference image.

Step S108: generating a target image by a target network model based on the target Gaussian noise map and the text prompt information.

The target network model may be implemented, for example, by a generative model, and in some specific examples, may be implemented using a diffusion model or a network model that includes a denoising network, the embodiments of the present disclosure are not limited thereto. In practical application, the target Gaussian noise map and the text prompt information may be input to the target network model to cause the target network model to output the target image. In addition, the target network model may also have other inputs, for example, a reference image may also be input to the target network model together to inject the coding features of the reference image into the target network model, the embodiments of the present disclosure are not limited thereto.

In the above-mentioned method provided by the embodiments of the present disclosure, in consideration of the influence of a noise map on an image generation effect, rather than using random noise, an initial Gaussian noise map is generated based on a reference image, and further based on information of a target object in the reference image and the initial Gaussian noise map, a target Gaussian noise map is generated, the target Gaussian noise map can carry target object information to a certain extent, and then a target network model is made to perform image generation based on the target Gaussian noise map and text prompt information, which helps to enable the final target image to better present target object features. Moreover, the above-mentioned method is more flexible in image editing, and it is ensured that the final target image obtained can better meet the user's needs.

In some embodiments, the above-mentioned step of generating the target Gaussian noise map based on the information of the target object and the initial Gaussian noise map in step S106 can be performed with reference to the following steps A-C.

Step A: determining a first Gaussian noise corresponding to a first region based on the information of the target object and the initial Gaussian noise map; in which the first region is at least part of a region in the target Gaussian noise map to be generated, and the first region is determined based on the target object in the reference image, in other words, the first region is related to the target object. In some specific examples, reference may be made to the following steps A1-A3.

Step A1: determining a target region noise in the initial Gaussian noise map based on a target object region of the reference image. The initial Gaussian noise map is consistent with the reference image in size, and the location of the target object region in the reference image is consistent with the location of the target region noise in the initial Gaussian noise map.

Step A2: scaling the target region noise based on the information of the target object to obtain a scaled region noise. The presentation type of the target object in the reference image may affect the scaling ratio of the target region noise, for example, when the target object is a full-body portrait, a head portrait, or a half-body portrait, and the scaling ratio required for the corresponding target region noise is different. Illustratively, the step A2 can be carried out with reference to the following steps A2.1 to A2.3.

Step A2.1: determining a presentation type of the target object in the reference image based on the information of the target object.

In some implementation examples, the presentation type of the target object includes: a first type, a second type, or a third type; the first type is used for indicating that all parts of the target object are present in the reference image; the second type is used for indicating that only a local part of the target object is present in the reference image, the local part includes at least a first specified part and a second specified part; the third type is used for indicating that only a first specified part of the target object is present in the reference image. Here, the first specified part and the second specified part may each include one or more parts. Illustratively, taking the target object being a person, an animal, or an anthropomorphic object as an example, the first specified part may include a head, or a head and a neck, and the second specified part may include an upper body part other than a head and a neck, etc. Specifically, the first specified part and the second specified part may be flexibly determined based on the type of the target object.

In some specific implementation examples, the target object is a person, an animal, or an anthropomorphic object, the first type is a full-body portrait type, the second type is a half-body portrait type, and the third type is a head portrait type. For the convenience of analysis and processing, the information of the target object can be directly characterized by the object segmentation map of the reference image, in which all the pixels in the region other than the target object are zero-pixels, in other words, only the pixels in the region of the target object in the object segmentation map are non-zero pixels. Step A2.1 may be performed with reference to the following steps: dividing the object segmentation map into an upper region and a lower region based on a center line of the object segmentation map, and calculating a first proportion of non-zero pixels in the upper region and a second proportion of non-zero pixels in the lower region; determining the presentation type of the target object in the reference image to be a head portrait type in response to both the first proportion and second proportion being greater than a preset first threshold; determining the presentation type of the target object in the reference image to be a half-body portrait type in response to the first proportion being less than a preset second threshold, and the second proportion being greater than the first threshold; in which the second threshold is less than the first threshold; and determining the presentation type of the target object in the reference image to be a full-body portrait type in response to both the first proportion and the second proportion being less than the second threshold. The first threshold and the second threshold may be flexibly set according to the requirements, embodiments of the present disclosure are not limited thereto. By means of the above-mentioned calculating ratios of non-zero pixels of the upper and lower parts of the image, the presentation type of the target object can be determined efficiently and conveniently, and it can be accurately determined whether the target object is presented in the head portrait type, the half-body portrait type or the full-body portrait type, and on this basis, it is helpful to perform subsequent processing for different presentation types.

Step A2.2: determining a target scaling strategy corresponding to the presentation type of the target object from a plurality of preset scaling strategies; in which the scaling ratios corresponding to different scaling strategies are different, the scaling ratio is equal to the scaled size/original size, that is to say, when the scaling ratio is greater than 1, it represents zooming in, when the scaling ratio is equal to 1, it represents not changing, and when the scaling ratio is less than 1, it represents zooming out. Illustratively, the scaling ratio corresponding to the first type is greater than the scaling ratio corresponding to the second type, and the scaling ratio corresponding to the second type is greater than the scaling ratio corresponding to the third type. In some specific examples, the scaling ratio corresponding to the first type is 1, the scaling ratios corresponding to the second type and the third type is less than 1, and the third type has the smallest scaling ratio. Taking the first type as the full-body portrait type, the second type as the half-body portrait type, and the third type as the head portrait type as an example, the full-body portrait type is not scaled, i.e. the corresponding scaling ratio is 1, and the scaling ratio corresponding to the half-body portrait type is greater than the scaling ratio corresponding to the head portrait type, i.e. the half-body portrait type needs a smaller degree of reduction, and the head portrait type needs a larger degree of reduction.

Step A2.3: scaling the target region noise based on the target scaling strategy to obtain a scaled region noise. That is, when the presentation type of the target object is the full-body portrait type, the scaling ratio adopted by the target scaling strategy may be 1, i.e., the target region noise may be kept unchanged. When the presentation type of the target object is the half-body portrait type, the scaling ratio adopted by the target scaling strategy is less than 1, and the noise of the target region is slightly reduced. When the presentation type of the target object is the head portrait type, the scaling ratio adopted by the target scaling strategy is less than 1, the target region noise is moderately reduced, and the degree of reduction of the target region noise corresponding to the head portrait type is greater than the degree of reduction of the target region noise corresponding to the half-body portrait type.

In the manner described above, the target region noise can be reasonably processed based on the presentation type of the target object, so that a more reasonable and reliable target noise image can be subsequently generated.

Step A3: obtaining the first Gaussian noise corresponding to the first region based on the scaled region noise. In some specific implementation examples, the step A3 can be performed with reference to the following steps A3.1 and A3.2.

Step A3.1: determining a region, where the scaled region noise corresponds to, in the target Gaussian noise map to be generated based on the presentation type of the target object, and taking the region determined as the first region; in which the first region has a preset relative positional relationship with a specified central position of the target Gaussian noise map, and relative positional relationships corresponding to different presentation types are different.

Illustratively, in response to the presentation type of the target object indicating that all parts of the target object are not all presented in the reference image, the first region is a non-central region of the target Gaussian noise map, i.e., when the presentation type of the target object is the second type or the third type, the corresponding first region is not located in the central region of the target Gaussian noise map, and the corresponding first region may be located on the upper side of the center of the target Gaussian noise map. When the presentation type of the target object indicates that all parts of the target object are presented in the reference image (namely, the presentation type of the target object is the first type), the corresponding first region may be located in the central region of the target Gaussian noise map. It should be noted that the central region of the reference image can be set in advance by means such as a central region boundary, and can be specifically set flexibly.

The above-mentioned relative positional relationship between the first region and the specified central position can be set according to requirements, for example, the relative orientation and distance between the center point of the first region and the specified central position (such as the center point of the target Gaussian noise map) can be set. For example, assuming that the relative positional relationship corresponding to the first type (referred to as a first relationship for short) indicates that the center point of the first region coincides with a specified central position or is within a preset threshold range from the specified central position, assuming that the relative positional relationship corresponding to the second type (referred to as a second relationship for short) and the relative positional relationship corresponding to the third type (referred to as a third relationship for short) both indicate that the center point of the first region is located above the specified central position, and the distance between the center point of the first region and the specified central position indicated by the second relationship is smaller than the distance between the center point of the first region and the specified central position indicated by the third relationship.

In the manner described above, the target relative positional relationship can be accurately and reliably determined from the plurality of preset relative positional relationships based on the presentation type of the target object, the first region can be reasonably determined based on the relative positional relationship of the target object, to ensure that the scaled region noise can be accurately located in the expected region in the target Gaussian noise map as far as possible, so as to ensure the concentration and consistency of the features of the target object, and for the types of the half-body portrait, head portrait, etc., sufficient space at the lower side of the image can be used to generate other parts of the body such as legs and feet, and the flexibility of model editing can be improved.

Step A3.2: taking the scaled region noise as the first Gaussian noise to which the first region corresponds. That is, the scaled region noise may be directly filled in the first region as the first Gaussian noise.

Step B: acquiring a second Gaussian noise corresponding to a second region; in which the second region is a region other than the first region in the target Gaussian noise map to be generated. Illustratively, the second Gaussian noise is random noise. The size of the target Gaussian noise map is consistent with the size of the reference image or the target image to be generated, and in response to the first region being determined through the step A3.1, the remaining region (i.e., the second region) may be directly filled with random noise.

Step C: generating the target Gaussian noise map based on the first Gaussian noise and the second Gaussian noise. In the manner described above, two kinds of Gaussian noise are superimposed to generate the target Gaussian noise map, which can effectively enrich the details and diversity of the image, while maintaining the overall consistency. In some embodiments, the first region may be directly filled with the first Gaussian noise, and the second region may be filled with the second Gaussian noise, the two are combined to obtain the target Gaussian noise map. In other implementation examples, the step C may be performed with reference to the following steps C1 and C2.

Step C1: performing weighted superposition processing on a first Gaussian noise corresponding to an edge region in the first region and the second Gaussian noise to obtain a third Gaussian noise corresponding to an edge region in the first region. The width of the edge region can be flexibly set on the basis of requirements, and the third Gaussian noise corresponding to the edge region can make a connection transition between the first Gaussian noise and the second Gaussian noise through the above-mentioned weighted superposition processing method, so as to reduce the edge fragmentation feeling between the first region and the second region, which is helpful to further improve the visual perception of the finally obtained image.

Step C2: generating the target Gaussian noise map based on a first Gaussian noise corresponding to a non-edge region in the first region, the third Gaussian noise corresponding to the edge region in the first region, and the second Gaussian noise corresponding to the second region. The target Gaussian noise map is obtained by combining the Gaussian noises corresponding to the above-mentioned regions.

In practical application, a random noise map can be acquired directly for the convenience of processing; in which the size of the random noise map is consistent with the size of the target Gaussian noise map to be generated; then, based on the position of the first region in the target Gaussian noise map to be generated, the random noise in the region corresponding to the first region in the random noise map is replaced with the first Gaussian noise, and the random noise in the region corresponding to the second region in the random noise map is kept unchanged, so as to obtain the target Gaussian noise map. Further, weighted superposition processing can be performed on the edge of the random noise and the first Gaussian noise in the random noise map after replacing to weaken the edge fragmentation feeling between the different noises.

For ease of understanding, reference may be made to a comparative schematic diagram of a target Gaussian noise map as shown in FIG. 2 below, in which the region represented by Z1 is a first region corresponding to a first Gaussian noise and the region represented by Z2 is a second region corresponding to a second Gaussian noise (random noise). Three target Gaussian noise maps are illustrated in FIG. 2, the left map corresponds to the head portrait type, the middle map corresponds to the half-body portrait type, and the right map corresponds to the full-body portrait type, i.e. for the head portrait, the first region is located on the upper side of the center to sufficiently leave the lower space to generate the upper and lower body halves, for the half-body portrait, the first region is located slightly above the center to properly leave the lower space to generate the lower body half, and for the full-body portrait, no adjustment may be required. The scaling ratio in FIG. 2 and the placement of the first region are exemplary and should not be construed as limiting. The target Gaussian noise maps obtained in the method described above is more convenient for the model to adjust the object features flexibly based on the noise map, and the model can realize better effects in view angle transformation, presentation mode transformation, and other large-amplitude transformation, so as to ensure that the model has a good image editing capability. In addition, because the first region in the target Gaussian noise map is strongly correlated with the target object, it is also helpful to ensure that the model can maintain the core features of the object so that the features of the object in the image generated by the model have high similarity with the features of the object in the reference image.

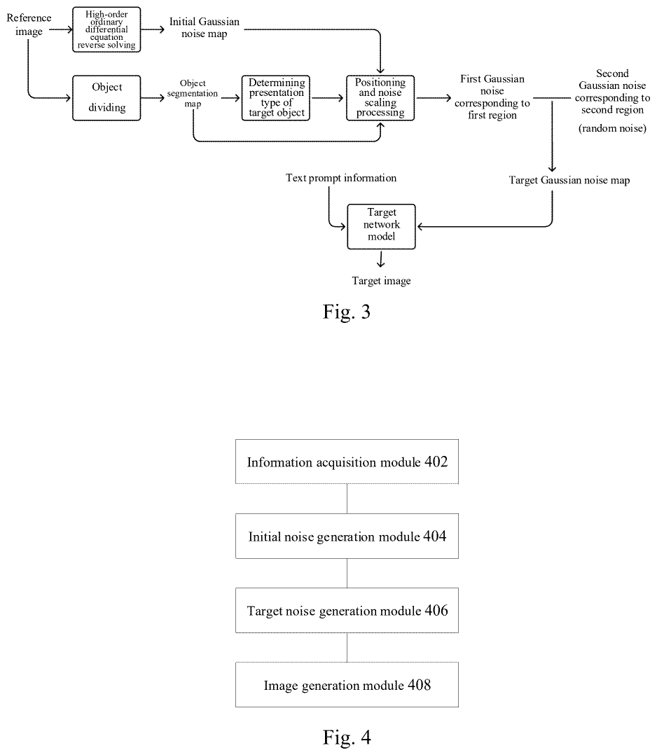

Furthermore, with reference to a schematic diagram of a flow of an image generation as shown in FIG. 3 provided by embodiments of the present disclosure, an initial Gaussian noise map can be obtained from a reference image input by a user by means of performing high-order ordinary differential equation reverse solving processing, and an object segmentation map can also be obtained further by means of object segmentation processing; the information of the target object in the reference image is characterized by the object segmentation map, and further an object presentation type is determined based on the object segmentation map, such as whether the target object belongs to the head portrait type, the half-body portrait type or the full-body portrait type; then, based on the initial Gaussian noise map, the object presentation type and the target object region indicated by the object segmentation map, the first region in the target Gaussian noise map to be generated and the corresponding first Gaussian noise can be determined by means of positioning and noise scaling processing, and combined with the second region in the target Gaussian noise map to be generated (namely, the region in the target Gaussian noise map other than the first region) and the corresponding second Gaussian noise (such as random noise), the target Gaussian noise can be synthesized. Then, the target Gaussian noise and the text prompt information are input into the target network model, and the target image can be obtained. Specific implementations of the above process can be made with reference to the foregoing and will not be described in detail herein.

In summary, the image generation method provided by the embodiments of the present disclosure is helpful to enable the finally obtained target image to better present the target object features, effectively guarantee the similarity between the object features in the image generated by the model and the reference image, and on this basis, can also better guarantee the image editing capability, improve the editing flexibility, enrich the object presentation effect of the image generated by the model, and comprehensively guarantee that the finally obtained target image can better meet the user's requirements.

Corresponding to the above-mentioned image generation method, the embodiments of the present disclosure further provide an image generation apparatus. FIG. 4 is a schematic diagram of a structure of an image generation apparatus provided by the embodiments of the present disclosure, which can be implemented by software and/or hardware, and can be generally integrated into an electronic device. As illustrated in FIG. 4, the image generation apparatus includes:
an information acquisition module 402, configured to acquire a reference image and text prompt information;
an initial noise generation module 404, configured to generate an initial Gaussian noise map based on the reference image;
a target noise generation module 406, configured to acquire information of a target object in the reference image, and generating a target Gaussian noise map based on the information of the target object and the initial Gaussian noise map; and
an image generation module 408, configured to generate a target image by a target network model based on the target Gaussian noise map and the text prompt information.

In the apparatus provided by the embodiments of the present disclosure, in consideration of the influence of a noise map on an image generation effect, rather than using random noise, an initial Gaussian noise map is generated based on a reference image, and further based on information of a target object in the reference image and the initial Gaussian noise map, a target Gaussian noise map is generated, the target Gaussian noise map can carry target object information to a certain extent, and then a target network model is made to perform image generation based on the target Gaussian noise map and text prompt information, which helps to enable the final target image to better present target object features. Moreover, the above-mentioned method is more flexible in image editing, and it is ensured that the final target image obtained can better meet the user's needs.

In some implementations, the initial noise generation module 404 is further configured to: perform high-order ordinary differential equation reverse solving processing on the reference image to obtain the initial Gaussian noise map.

In some implementations, the initial noise generation module 404 is further configured to: determine a first Gaussian noise corresponding to a first region based on the information of the target object and the initial Gaussian noise map; in which the first region is at least part of a region in the target Gaussian noise map to be generated, and the first region is determined based on the target object in the reference image; acquire a second Gaussian noise corresponding to a second region; in which the second region is a region other than the first region in the target Gaussian noise map to be generated; and generate the target Gaussian noise map based on the first Gaussian noise and the second Gaussian noise.

In some implementations, the initial noise generation module 404 is further configured to: determine a target region noise in the initial Gaussian noise map based on a target object region of the reference image; scale the target region noise based on the information of the target object to obtain a scaled region noise; and obtain the first Gaussian noise corresponding to the first region based on the scaled region noise.

In some implementations, the initial noise generation module 404 is further configured to: determine a presentation type of the target object in the reference image based on the information of the target object; determine a target scaling strategy corresponding to the presentation type of the target object from a plurality of preset scaling strategies; in which scaling ratios corresponding to different scaling strategies are different; and scale the target region noise based on the target scaling strategy to obtain the scaled region noise.

In some implementations, the presentation type of the target object comprises: a first type, a second type, or a third type; the first type is used for indicating that all parts of the target object are present in the reference image; the second type is used for indicating that only a local part of the target object is present in the reference image, and the local part comprises at least a first specified part and a second specified part; the third type is used for indicating that only the first specified part of the target object is present in the reference image.

In some implementations, the first type is a full-body portrait type, the second type is a half-body portrait type, and the third type is a head portrait type; the information of the target object is characterized by an object segmentation map of the reference image, pixels in a region in the object segmentation map except for the target object are all zero-pixels; the initial noise generation module 404 is further configured to: divide the object segmentation map into an upper region and a lower region based on a center line of the object segmentation map, and calculate a first proportion of non-zero pixels in the upper region and a second proportion of non-zero pixels in the lower region; determine the presentation type of the target object in the reference image to be the head portrait type in response to both the first proportion and second proportion being greater than a first threshold that is preset; determine the presentation type of the target object in the reference image to be the half-body portrait type in response to the first proportion being less than a second threshold that is preset, and the second proportion being greater than the first threshold; in which the second threshold is less than the first threshold; and determine the presentation type of the target object in the reference image to be the full-body portrait type in response to both the first proportion and the second proportion being less than the second threshold.

In some implementations, a scaling ratio corresponding to the first type is greater than a scaling ratio corresponding to the second type, and the scaling ratio corresponding to the second type is greater than a scaling ratio corresponding to the third type.

In some implementations, the initial noise generation module 404 is further configured to: determine a region, where the scaled region noise corresponds to, in the target Gaussian noise map to be generated based on the presentation type of the target object, and take the region determined as the first region; in which the first region has a preset relative positional relationship with a specified central position of the target Gaussian noise map, and relative positional relationships corresponding to different presentation types are different; and take the scaled region noise as the first Gaussian noise to which the first region corresponds.

In some implementations, the initial noise generation module 404 is further configured to: perform weighted superposition processing on a first Gaussian noise corresponding to an edge region in the first region and the second Gaussian noise to obtain a third Gaussian noise corresponding to the edge region in the first region; and generate the target Gaussian noise map based on a first Gaussian noise corresponding to a non-edge region in the first region, the third Gaussian noise corresponding to the edge region in the first region, and the second Gaussian noise corresponding to the second region.

The image generation apparatus provided by the embodiments of the present disclosure can execute the image generation method provided by any embodiment of the present disclosure, and has functional modules and beneficial effects corresponding to the method.

Those skilled in the art can clearly understand that, for convenience and conciseness of the description, for the specific working process of the apparatus embodiment described above, references can be made to the corresponding process in the method embodiments, which will not be repeated here.

The embodiments of the present disclosure provide an electronic device, the electronic device includes: a storage apparatus on which a computer program is stored; and a processing apparatus for executing the computer program in the storage apparatus to implement the steps of any one of the methods provided by the embodiments of the present disclosure.

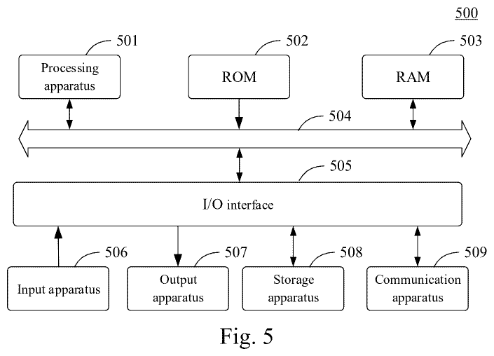

Referring to FIG. 5, FIG. 5 illustrates a schematic structural diagram of an electronic device 500 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 5 is merely an example, and should not pose any limitation to the functions and the range of use of the embodiments of the present disclosure.

As illustrated in FIG. 5, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected by means of a bus 504. An input/output (I/O) interface 505 is also connected to the bus 504.

Usually, the following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 5 illustrates the electronic device 500 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

In addition to the method and apparatus described above, embodiments of the present disclosure may also provide a computer program product including computer a program instruction, when the computer program instruction is executed by a processing apparatus, the processing apparatus is caused to perform the image processing method provided by the embodiments of the present disclosure. The computer program product for performing the operations of the present disclosure may include a program code written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server.

In addition, the embodiments of the present disclosure may also provide a computer-readable storage medium, storing a computer program, when the computer program is run on a processing apparatus, the processing apparatus is caused to perform the image generation method provided by the embodiments of the present disclosure.

The above-mentioned computer-readable storage medium may be one readable medium of a combination of a plurality of readable media. The readable medium may be a readable signal medium or a readable storage medium. For example, the readable storage medium may be, but not limited to, an electric, magnetic, optical, electromagnetic, infrared, or semiconductor system, apparatus or device, or any combination thereof. More specific examples of the readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them.

Embodiments of the present disclosure also provide a computer program product, which includes a computer program/instruction, and when the computer program/instruction is executed by a processing apparatus, the processing apparatus is caused to perform the image generation method provided by the embodiments of the present disclosure.

It can be understood that before the technical solution disclosed in each embodiment of the present disclosure is used, the user should be informed of the type, use scope, use scenario, and the like of the personal information involved in the present disclosure in an appropriate manner in accordance with relevant laws and regulations, and the user's authorization should be obtained.

For example, when a user's active request is received, prompt information is sent to the user to explicitly prompt the user that the operation requested by the user will need to obtain and use the user's personal information. Therefore, the user can independently choose whether to provide personal information to software or hardware such as an electronic device, an application, a server, or a storage medium that executes the operation of the technical solution of the present disclosure based on the prompt information.

As an optional but non-limiting implementation, in response to receiving the user's active request, for example, the prompt information may be sent to the user in a pop-up window, and the prompt information may be presented in the pop-up window in text. In addition, the pop-up window may also carry a selection control for the user to select “agree”or “disagree”to provide personal information to the electronic device.

It can be understood that the above notification and user authorization obtaining process are only illustrative and do not limit the implementations of the present disclosure. Other methods that comply with relevant laws and regulations may also be applied to the implementations of the present disclosure.

In addition, it can be understood that the data involved in this technical solution (including but not limited to the data itself, the acquisition or use of data) should comply with the requirements of corresponding laws and regulations and related regulations.

It should be noted that relational terms such as “first” and “second” are used herein only to distinguish between one entity or operation and another entity or operation, and are not necessarily intended to require or imply any actual relationship or order between these entities or operations. Moreover, the term “include/comprise” or any other variation thereof is intended to cover a non-exclusive inclusion, such that a process, method, article, or device that includes a list of elements includes not only those elements but also other elements not expressly listed, or elements that are inherent to such a process, method, article, or device. Without more limitations, an element defined by a statement “include/comprise one . . . ” does not exclude that there are other same elements in the process, method, article, or device that includes the element.

The above are only specific implementations of the present disclosure, and enable those skilled in the art to understand or implement the present disclosure. Various modifications to these embodiments will be apparent to those skilled in the art, and the general principles defined herein may be implemented in other embodiments without departing from the spirit or scope of the present disclosure. Therefore, the present disclosure is not limited to these embodiments described herein, but is to be accorded the widest scope consistent with the principles and novel features disclosed herein.

1. An image generation method, comprising:
acquiring a reference image and text prompt information;
generating an initial Gaussian noise map based on the reference image;
acquiring information of a target object in the reference image, and generating a target Gaussian noise map based on the information of the target object and the initial Gaussian noise map; and
generating a target image by a target network model based on the target Gaussian noise map and the text prompt information.

2. The method according to claim 1, wherein the generating an initial Gaussian noise map based on the reference image comprises:
performing high-order ordinary differential equation reverse solving processing on the reference image to obtain the initial Gaussian noise map.

3. The method according to claim 1, wherein the generating a target Gaussian noise map based on the information of the target object and the initial Gaussian noise map comprises:
determining a first Gaussian noise corresponding to a first region based on the information of the target object and the initial Gaussian noise map; wherein the first region is at least part of a region in the target Gaussian noise map to be generated, and the first region is determined based on the target object in the reference image;
acquiring a second Gaussian noise corresponding to a second region; wherein the second region is a region other than the first region in the target Gaussian noise map to be generated; and
generating the target Gaussian noise map based on the first Gaussian noise and the second Gaussian noise.

4. The method according to claim 3, wherein the determining a first Gaussian noise corresponding to a first region based on the information of the target object and the initial Gaussian noise map comprises:
determining a target region noise in the initial Gaussian noise map based on a target object region of the reference image;
scaling the target region noise based on the information of the target object to obtain a scaled region noise; and
obtaining the first Gaussian noise corresponding to the first region based on the scaled region noise.

5. The method according to claim 4, wherein the scaling the target region noise based on the information of the target object to obtain a scaled region noise comprises:
determining a presentation type of the target object in the reference image based on the information of the target object;
determining a target scaling strategy corresponding to the presentation type of the target object from a plurality of preset scaling strategies; wherein scaling ratios corresponding to different scaling strategies are different; and
scaling the target region noise based on the target scaling strategy to obtain the scaled region noise.

6. The method according to claim 5, wherein the presentation type of the target object comprises: a first type, a second type, or a third type;
wherein the first type is used for indicating that all parts of the target object are present in the reference image; the second type is used for indicating that only a local part of the target object is present in the reference image, and the local part comprises at least a first specified part and a second specified part; the third type is used for indicating that only the first specified part of the target object is present in the reference image.

7. The method according to claim 6, wherein the first type is a full-body portrait type, the second type is a half-body portrait type, and the third type is a head portrait type; the information of the target object is characterized by an object segmentation map of the reference image, pixels in a region in the object segmentation map except for the target object are all zero-pixels;
wherein the determining a presentation type of the target object in the reference image based on the information of the target object comprises:
dividing the object segmentation map into an upper region and a lower region based on a center line of the object segmentation map, and calculating a first proportion of non-zero pixels in the upper region and a second proportion of non-zero pixels in the lower region;
determining the presentation type of the target object in the reference image to be the head portrait type in response to both the first proportion and second proportion being greater than a first threshold that is preset;
determining the presentation type of the target object in the reference image to be the half-body portrait type in response to the first proportion being less than a second threshold that is preset, and the second proportion being greater than the first threshold; wherein the second threshold is less than the first threshold; and
determining the presentation type of the target object in the reference image to be the full-body portrait type in response to both the first proportion and the second proportion being less than the second threshold.

8. The method according to claim 6, wherein a scaling ratio corresponding to the first type is greater than a scaling ratio corresponding to the second type, and the scaling ratio corresponding to the second type is greater than a scaling ratio corresponding to the third type.

9. The method according to claim 5, wherein the obtaining the first Gaussian noise corresponding to the first region based on the scaled region noise comprises:
determining a region, where the scaled region noise corresponds to, in the target Gaussian noise map to be generated based on the presentation type of the target object, and taking the region determined as the first region; wherein the first region has a preset relative positional relationship with a specified central position of the target Gaussian noise map, and relative positional relationships corresponding to different presentation types are different; and
taking the scaled region noise as the first Gaussian noise to which the first region corresponds.

10. The method according to claim 3, wherein the second Gaussian noise is random noise; and the generating a target Gaussian noise map based on the first Gaussian noise and the second Gaussian noise comprises:
performing weighted superposition processing on a first Gaussian noise corresponding to an edge region in the first region and the second Gaussian noise to obtain a third Gaussian noise corresponding to the edge region in the first region; and
generating the target Gaussian noise map based on a first Gaussian noise corresponding to a non-edge region in the first region, the third Gaussian noise corresponding to the edge region in the first region, and the second Gaussian noise corresponding to the second region.

11. An electronic device, comprising:
a storage apparatus, on which a computer program is stored;
a processing apparatus, configured to execute the computer program in the storage apparatus to:
acquire a reference image and text prompt information;
generate an initial Gaussian noise map based on the reference image;
acquire information of a target object in the reference image, and generating a target Gaussian noise map based on the information of the target object and the initial Gaussian noise map; and
generate a target image by a target network model based on the target Gaussian noise map and the text prompt information.

12. The electronic device according to claim 11, wherein the processing apparatus is further configured to:
perform high-order ordinary differential equation reverse solving processing on the reference image to obtain the initial Gaussian noise map.

13. The electronic device according to claim 11, wherein the processing apparatus is further configured to:
determine a first Gaussian noise corresponding to a first region based on the information of the target object and the initial Gaussian noise map; wherein the first region is at least part of a region in the target Gaussian noise map to be generated, and the first region is determined based on the target object in the reference image;
acquire a second Gaussian noise corresponding to a second region; wherein the second region is a region other than the first region in the target Gaussian noise map to be generated; and
generate the target Gaussian noise map based on the first Gaussian noise and the second Gaussian noise.

14. The electronic device according to claim 13, wherein the processing apparatus is further configured to:
determine a target region noise in the initial Gaussian noise map based on a target object region of the reference image;
scale the target region noise based on the information of the target object to obtain a scaled region noise; and
obtain the first Gaussian noise corresponding to the first region based on the scaled region noise.

15. The electronic device according to claim 14, wherein the processing apparatus is further configured to:
determine a presentation type of the target object in the reference image based on the information of the target object;
determine a target scaling strategy corresponding to the presentation type of the target object from a plurality of preset scaling strategies; wherein scaling ratios corresponding to different scaling strategies are different; and
scale the target region noise based on the target scaling strategy to obtain the scaled region noise.

16. The electronic device according to claim 15, wherein the presentation type of the target object comprises:
a first type, a second type, or a third type;
wherein the first type is used for indicating that all parts of the target object are present in the reference image; the second type is used for indicating that only a local part of the target object is present in the reference image, and the local part comprises at least a first specified part and a second specified part; the third type is used for indicating that only the first specified part of the target object is present in the reference image.

17. The electronic device according to claim 16, wherein the first type is a full-body portrait type, the second type is a half-body portrait type, and the third type is a head portrait type; the information of the target object is characterized by an object segmentation map of the reference image, pixels in a region in the object segmentation map except for the target object are all zero-pixels;
the processing apparatus is further configured to:
divide the object segmentation map into an upper region and a lower region based on a center line of the object segmentation map, and calculating a first proportion of non-zero pixels in the upper region and a second proportion of non-zero pixels in the lower region;
determine the presentation type of the target object in the reference image to be the head portrait type in response to both the first proportion and second proportion being greater than a first threshold that is preset;
determine the presentation type of the target object in the reference image to be the half-body portrait type in response to the first proportion being less than a second threshold that is preset, and the second proportion being greater than the first threshold; wherein the second threshold is less than the first threshold; and
determine the presentation type of the target object in the reference image to be the full-body portrait type in response to both the first proportion and the second proportion being less than the second threshold.

18. The electronic device according to claim 16, wherein a scaling ratio corresponding to the first type is greater than a scaling ratio corresponding to the second type, and the scaling ratio corresponding to the second type is greater than a scaling ratio corresponding to the third type.

19. The electronic device according to claim 15, wherein the processing apparatus is further configured to:
determine a region, where the scaled region noise corresponds to, in the target Gaussian noise map to be generated based on the presentation type of the target object, and take the region determined as the first region; wherein the first region has a preset relative positional relationship with a specified central position of the target Gaussian noise map, and relative positional relationships corresponding to different presentation types are different; and
take the scaled region noise as the first Gaussian noise to which the first region corresponds.

20. A non-transitory computer-readable storage medium, storing a computer program thereon that causes a processor to:
acquire a reference image and text prompt information;
generate an initial Gaussian noise map based on the reference image;
acquire information of a target object in the reference image, and generating a target Gaussian noise map based on the information of the target object and the initial Gaussian noise map; and
generate a target image by a target network model based on the target Gaussian noise map and the text prompt information.
